(19) United States
(12) Patent Application Publication
(10) Pub. No.: US 2004/0230414 A1
(43) Pub. Date: Nov. 18, 2004

(54) Method for verification of hardware designs with multiple asynchronous frequency domains

(75) Inventors: Bodo E. Hoppe, Tam (DE); Sabina Joseph, Poughkeepsie, NY (US); Haresh Kumar, Poughkeepsie, NY (US); Jose F. Silverio, Danbury, CT (US)

Correspondence Address: Philmore H. Colburn II, Cantor Colburn LLP, 55 Griffin Road South, Bloomfield, CT, 06002, US

(73) Assignee: INTERNATIONAL BUSINESS MACHINES CORPORATION, ARMONK, NY

(21) Appl. No.: 10/435,973

(22) Filed: May 12, 2003

(51) Int. Cl. G06F 17/50

(52) U.S. Cl. 703/14

(57) ABSTRACT

The complexity of present ASIC designs has increased considerably with the integration of multiple asynchronous frequency clock domains. The verification of these hardware models before actual tape out has become more and more important. A system and method are described herein to perform asynchronous stress testing using a single cycle random simulation environment. The system and method both include three phases. First, the domain frequency values are manipulated and a greatest common factor (GCF) mathematical approach is used to calculate a common unit of time. Secondly, corresponding default simulation cycles per system clock for each domain are calculated using the common unit of time determined from the previous phase. Lastly, a stress test is performed by randomly selecting a specific range above and below the default simulation cycle value for each clock domain. The method can be integrated as part of the single cycle random simulation environment, thus becoming added feature to an existing environment which is used for all functional verification. In addition, the method is used early in the design verification cycle before tape out, thus providing considerable cost savings in the event of hardware bugs.

### FIELD OF THE INVENTION

The invention is particularly directed to design verification of individual integrated circuit devices containing multiple asynchronous clock frequency domains.

### BACKGROUND

As semiconductor fabrication technology advances, designers of integrated circuits and electronic circuits incorporating the same are able to integrate more and more functions into individual integrated circuit devices, or chips. As such, electronic designs that once required several integrated circuits electrically coupled to one another on a circuit board or module may now be integrated into fewer integrated circuits, thereby increasing performance and reducing cost.

With increases in circuit complexity, however, the processes of designing and testing circuit designs have become increasingly complex and time consuming. As a result, computers have become increasingly important in automating the design and testing of circuit designs.

An important step in the development of a complex electronic system is that of verification, which is used to verify the functional operation of a circuit design. Simulation-based testing is the most commonly-used method for verifying integrated circuit hardware designs. Traditionally, hardware circuit designs have been designed on a computer at a relatively high level of abstraction, typically in a hardware definition language such as VHDL or Verilog.

Software tools, known as compilers, are then used to generate simulation models for the designs that can be executed on a logic simulator computer program to simulate the reactions of such circuit designs to various input conditions. By simulating the functional operation of a circuit design, potential errors or faulty logic can be identified and corrected in the high level design. Simulation is then rerun until the circuit design functions as desired.

However, with the increasingly complex nature of many circuit designs, software-based simulation is often too time consuming and inefficient. As a result, a significant amount of development effort has been directed toward hardware-based verification environments such as cycle simulators.

Cycle simulation, for example, is used to verify the functionality of a circuit design by calculating the outputs of circuit components at clock edges, with typically only two logic states (binary 1 and 0) computed for each component output.

Any complex application specific integrated circuit (ASIC) design may integrate multiple frequency domains. For instance, an ASIC that supports a layered structure for its input/output (I/O) ports, contains a physical adaptation layer (PAL), a data link adaptation layer (DLAL), and a transport adaptation layer (TAL). Each one of these layers runs at a different clock frequency while an ASIC may include several I/O ports. In addition, the same ASIC may contain several clock domains internal to its host logic. These internal clock domains may be referred to as host clock logic (HCL) domains. Typically, any given ASIC contains maintenance logic (ML) which runs at a much slower frequency compared with the rest of the chip logic.

Verification of the STI Switch chip is performed with an IBM-designed cycle simulator called ZFS. With a cycle simulator such as ZFS, the detailed timing of the logic circuits is ignored, and the state of the logic is evaluated on clock cycle boundaries. A single cycle simulator (ZFS), a software-event-driven cycle simulator, used to verify the functionality of the STI Switch chip, divides time into discrete simulation cycles. Usually, one simulation cycle corresponds to the shortest clock period within the hardware model. However, with the many different clock frequencies in the model, representing one simulation cycle as one system clock cycle may not be feasible and may prove to be prohibited, from a model performance point of view, while proper modeling with respect to the different asynchronous interfaces within the STI switch chip is an important aspect that needs to be considered.

In typical I/O chip environments, a manual approach is implemented to determine the simulation cycles per system clock cycle relationships, and stress testing across the various frequency domains is not performed until after tape out ( release to manufacturing). Performing this testing before release to manufacturing, would provide considerable cost savings in the event of hardware bugs, since it would be performed much earlier in the verification process. Tight development schedules and cost efficiencies associated with reducing the number of chip design passes, or ““RITS,”” require new methods for verifying interfaces.

Therefore, a significant need continues to exist in the art for a manner of facilitating the verification of various asynchronous frequency domains in an ASIC such as in a STI switch chip, for example. In particular, a need exists for overcoming the limitation of the prior art approach to determine the simulation cycles per system clock cycles relationships, and stress testing across the various frequency domains before tape out or release to manufacturing.

### SUMMARY OF THE INVENTION

This invention provides an automated methodology for representing default simulation cycle relationships and for verifying the various asynchronous clock domains by stressing the frequencies across the internal interfaces using a random simulation environment.

A system for verification of multiple asynchronous frequency clock domains in an electronic device includes a random simulation environment configured to receive the multiple frequency clock domain values and determine a greatest common factor (GCF) of the multiple clock domain values to calculate a common unit of time as a system clock. Next, a corresponding number of default simulation cycles is calculated based on the system clock for each clock domain. A stress test is optionally performed by randomly selecting a specific range above and below the default simulation cycle value for each clock domain.

A method of verification of various asynchronous frequency domains in an electronic device in a random simulation environment is also disclosed herein. The method comprises inputting multiple domain clock frequency values; determining whether any of the domain clock frequency values are decimal fractions; and calculating a default domain simulation cycle by finding the greatest common factor (GCF) if there are no decimal fractions to represent each clock domain. A stress test is optionally performed by randomly varying the default simulation cycle value for each clock domain.

The above-described and other features and advantages of the present invention will be appreciated and understood by those skilled in the art from the following detailed description, drawings, and appended claims.

### DESCRIPTION OF THE DRAWINGS

FIG. 1 is a chip block diagram of a multi-frequency ASIC illustrating different clock domains thereof;

FIG. 2 is a block diagram that schematically illustrates a system for design verification, in accordance with an exemplary embodiment of the present invention; and

FIG. 3 is a flow chart that schematically illustrates a method for design verification using a GCF evaluation phase, a default domain simulation cycle calculation phase, and an asynchronous stress test phase, in accordance with an exemplary embodiment of the present invention.

The following detailed description explains an exemplary embodiment of the present invention, together with advantages and features, by way of example with reference to the drawings.

### DETAILED DESCRIPTION OF THE INVENTION

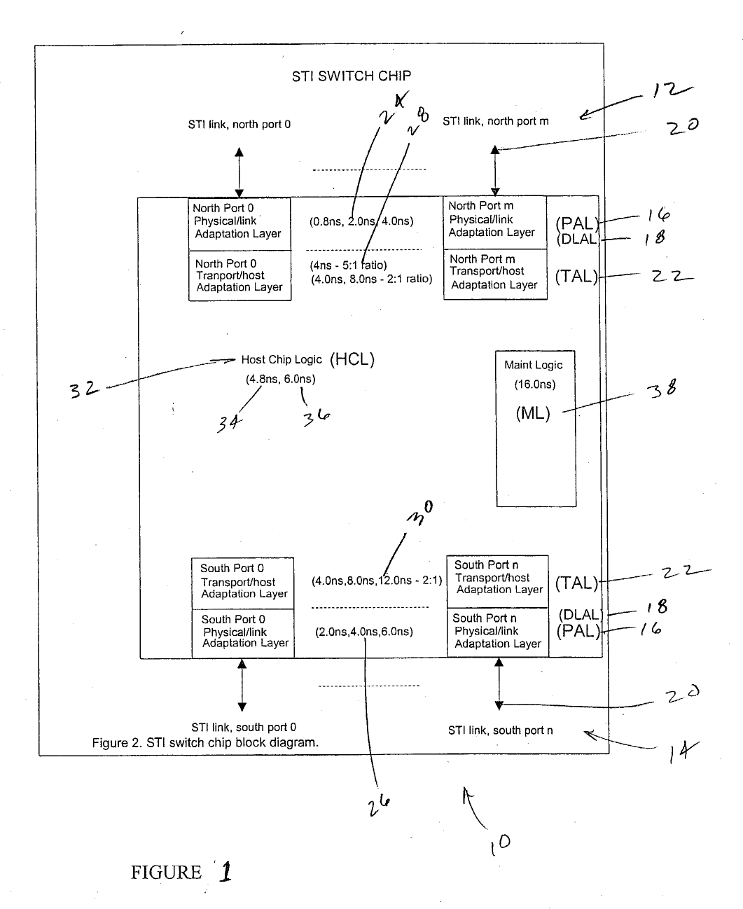

In one exemplary embodiment of an ASIC operating at different clock frequencies, FIG. 1 illustrates a self timed interface (STI) switch chip 10 that is considered a frequency matching chip. The STI switch chip 10 matches higher frequencies on the north port links or interfaces generally shown at 12 with slower frequencies on the south port links or interfaces generally shown at 14. For this purpose, and attached to each port, the STI switch chip 10 supports a physical adaptation layer (PAL) 16 with a data link adaptation layer (DLAL) 18, which interfaces with the STI link 20, and a transport adaptation layer (TAL) 22 which connects with the host logic.

The STI Switch chip can be configured to run in memory bus adapter (MBA) mode, Enhanced STI (ESTI) link on the north port, running at 0.8 ns, or in Cascade mode, Multi-frequency STI (MSTI) link on the north port, running at 2.0 ns or 4.0 ns generally shown at 24. Up to four ports can be enabled on the south port side 14. Each one of these ports can be connected to a MSTI link running at 2.0 ns, 4.0 ns, or 6.0 ns generally shown at 26. The link adaptation layers support a frequency ratio, relative to the logical adaptation layer, of 5:1(4.0 ns) for the ESTI port generally shown at 28, and of 2:1 for the MSTI ports (4.0 ns, 8.0 ns, and 12.0 ns respectively) generally shown at 30. In addition, the host chip logic (HCL) 32 can be configured to operate at 4.8 ns (MBA mode) 34, and at 6.0 ns (Cascade mode) 36. The maintenance logic(ML) 38, which has its own free running clock domain, operates at 16.0 ns. Considering both configuration modes of operation, i.e., MBA and Cascade modes 34 and 36, a total of eight different clock frequencies need to be supported.

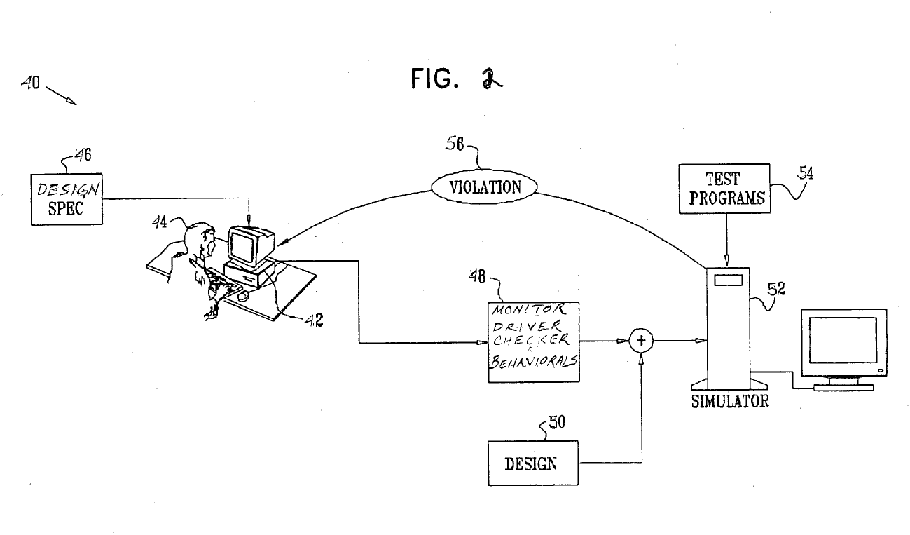

FIG. 2 is a block diagram that schematically illustrates a system 40 for design verification of chip 10, for example, performing design simulation, in accordance with a preferred embodiment of the present invention. A verification engineer 44 inputs a design specification 46 to a behavioral checker 42. The behavioral checker typically comprises a general-purpose computer, which is equipped with software for developing behaviorals from specification 46 into functional checker programs 48 in a description language. The software used by checker 42 in carrying out such operations may be supplied to the computer on tangible media, such as CD-ROM, or it may alternatively be downloaded to the computer in electronic form, over a network, for example. Typically, although not necessarily, the software is supplied as part of a suite of programs for functional verification.

Behavioral checkers 48 are linked to a design 50 of a hardware device in development, which may be written in the same hardware description language as the behavioral checkers. The hardware description language may be a dedicated hardware description language, such as VHDL or Verilog, or it may alternatively be a generally-purpose software language, such as C/C++, which is used for modeling the behavior of hardware designs in development. The checkers and design are compiled together and then run on a simulator 52, using methods of simulation known in the art. The simulator exercises design 50 in accordance with test programs 54, which may be generated automatically or written by engineer 54 or other personnel.

During simulation, checkers 48 detect violations of the properties in specification 46 and cause simulator 52 to output indications 56 of violations that have occurred. These indications are provided to engineer 44 and/or to other users. Depending on the information provided about any given violation, the user concerned may decide to fix design 50, change the design specification 46, or modify test programs 54. The checkers and design are then recompiled, and simulator 52 is run again until the design is bug-free and no more property violations are encountered.

To perform functional verification of the design of a device, a user reads the definition and functional specifications of the device and then, based on this information, writes a set of properties (also known as a specification) that the design is expected to fulfill. The properties are written in a suitable specification language for expressing logic relationships between the inputs and outputs of the device. Such languages are commonly based on C or C++. The circuit chip logic operating at multiple frequency domains then may be verified and stressed using a single cycle simulator as discussed more fully below. A hardware model (also known as an implementation) of the design is then tested to ascertain that the model satisfies all of the properties in the set.

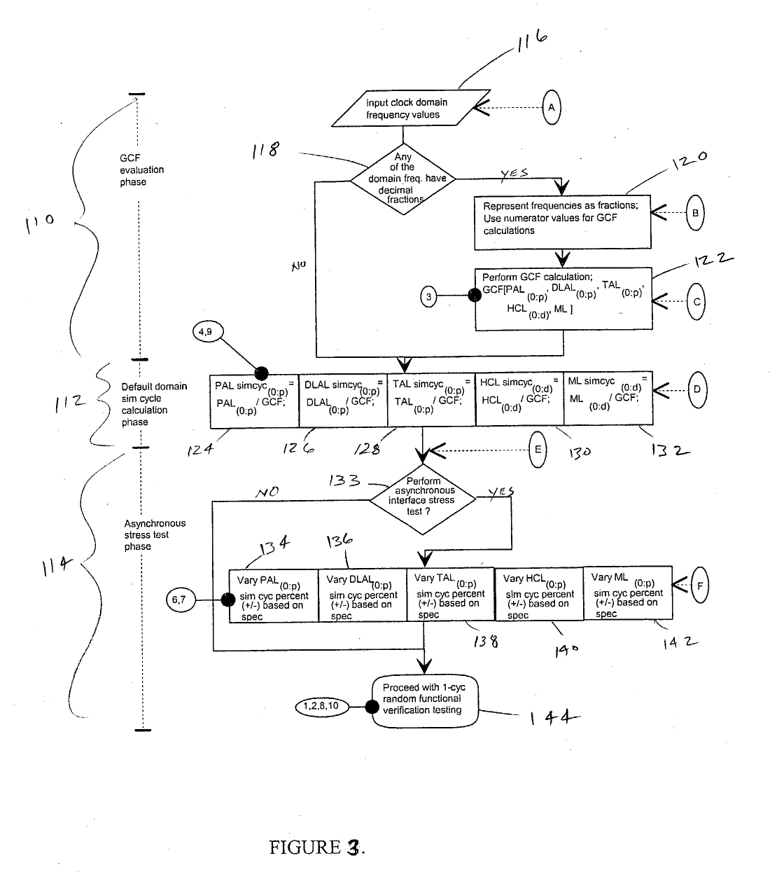

This disclosure provides a three phase solution to the problem of performing stress testing across multiple frequency domains. The overall algorithm is divided into three phases: a greatest common factor (GCF) evaluation phase 110, a default domain simulation cycle calculation phase 112, and an asynchronous stress test phase 114. FIG. 3 illustrates bubbles (A) through (F) which represent script files or portions of scripts integrated as part of a random simulation cycle environment.

As shown in FIG. 3, within the GCF evaluation phase 110, all clock domain frequency values are inputted at block 116. At block 118, the group of frequency values input at block 116 are evaluated to determine if any of the inputted frequency values contains decimal fractions. Script (A) reads the frequency values from an input file where these frequencies are tabulated on a per logic domain basis. If any decimal values are present, then proceed to block 120 to represent all frequency values as decimal fractions, which is handled by script (B). The numerator portions of these fractions are then used to calculate the greatest common factor (GCF), (i.e. 0.8 ns=8/10 ns ; factoring the numerator results in 1, 2, 4, 8 as factors of 8). After the GCF between all numerators is determined at block 122, the GCF is divided by the common denominator, i.e., 10, to obtain the unit of time value. The resulting fraction is later converted back to a decimal representation to arrive at a real unit of time value or common unit of time. The resulting decimal representation of the common unit of time is equated to the random single simulation cycle environment. For this purpose, the ‘Greatest Common Factor’ (GCF) mathematical approach is used, wherein script (C) is invoked for this purpose.

This can be represented as follows:

GCF[PAL_{(0:p)},DLAL_{(0:p)}, TAL_{(0:d)}, ML_{(0:d)}];

where the subscript (0:p) indicates that the ASIC design may contain any number of ports from 0 to p (0:p). The host chip logic and maintenance logic may contain any number of clock domains from 0 to d (0:d).

If the frequency values do not include any decimal representations at block 118, then proceed directly to the second phase 112 of the algorithm bypassing blocks 120 and 122. The second phase 112 of the algorithm involves a procedure to calculate default discrete simulation cycle values for each clock domain.

First, all of the frequency domains are represented as simulation cycles relationships, where several simulation cycles represent a system clock cycle. These are considered the default simulation cycles for each clock domain. The following formula is integrated in script (D), and is used to calculate the default simulation cycles for each clock domain at blocks 124, 126, 128, 130, and 132:

[number of domain default simulation cycles=(domain frequency/GCF)];

Phase 112 of the method ensures that the most efficient unit of time, represented in simulation cycles, is determined. Phase 112 ensures that an appropriate default simulation cycle value is selected to represent each of the different clock domains and provide the most efficient model performance.

The third and last phase 114 of the algorithm, is the procedure to integrate the calculated default simulation cycle values for each domain within the single cycle random environment and perform the asynchronous stress test. The default simulation cycles (“sim cycle”) relationships are inputted by each driver or monitor behavioral corresponding to each clock domain frequency. The interface driver and monitor behaviorals make use of the PAL sim cycle values. This is true for all port interfaces. The clock drivers and internal monitor behaviorals use the default PAL, DLAL, TAL, HCL, and ML sim cycle values. Script (E) provides these default simulation cycles values to all of the behaviorals.

If it is determined that asynchronous stress testing is not required at block 133, then the single random simulation can proceed at block 144, where the default simulation cycle values represent the various frequency domains. On the other hand, if asynchronous stress testing is required, then each of the default simulation cycles representations is varied for each corresponding domain at blocks 134, 136, 138, 140 and 142. This variation is based on the design specifications and it can be varied a certain percentage above and below the default simulation cycle value. The minimum variation is preferably at least one simulation cycle. The default sim cycle variation is selected at random on a per test case basis. These random values are selected at the beginning of each simulation run and is handled by script (F). This random selection is performed independently for each asynchronous frequency domain. Once the new stress test values are set, the single cycle random environment simulation can proceed at block 144 with all functional verification. It is also contemplated that performing asynchronous interface stress testing at phase 114 also includes dynamic control of the asynchronous interfaces using programmable independent oscillators.

The design verification method described herein, provides the appropriate selection of the simulation cycles per system clock cycles relationships for the different frequency domains, and the method ensures that stress testing, across the various asynchronous interfaces, is performed when running a single cycle random simulation environment. From a performance point of view the single cycle model is more efficient than a two cycle model, as well as being more efficient than an event driven environment, such as MTI. For this reason, the single cycle random simulation environment is normally used for all functional verification.

By randomly selecting the simulation cycle percent variation across the various asynchronous interfaces, all domain cycle relationships are non-integer multiples of each other. This ensures that the asynchronous interfaces are stressed properly. Therefore, by varying the ranges we are in fact stressing the limits of the design. And as a result of performing asynchronous stress testing, logical problems such as, buffer underruns, buffer overruns, and protocol violations can be identified.

The above disclosed method of randomly selecting the simulation cycle percent variation ensures that all domain cycle relationships are non-integer multiples of each other. In this manner, the various asynchronous interfaces within the chip are stressed properly. It should also be noted that each percent domain variation is defined based on the limitations of the design specifications. This depends on the actual design protocols and buffer implementation algorithms. As the ranges are varied, the basic idea is to mimic the real environment as closely as possible. Furthermore, although the description herein refers to verification of a hardware design, the system, as well as the underlying principles of the present invention, may equally be adapted for simulation testing of software and other complex designs.

The description applying the above embodiments is merely illustrative. As described above, embodiments in the form of computer-implemented processes and apparatuses for practicing those processes may be included. Also included may be embodiments in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Also included may be embodiments in the form of computer program code, for example, whether stored in a storage medium, loaded into and/or executed by a computer, or as a data signal transmitted, whether a modulated carrier wave or not, over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include, all embodiments falling within the scope of the appended claims.

What is claimed is:

1. A system for verification of multiple asynchronous frequency clock domains in an electronic device, comprising:
a random simulation environment configured to;
receive the multiple frequency clock domain values;
determine a greatest common factor (GCF) of the multiple clock domain values to calculate a common unit of time as a system clock;
calculate corresponding number of default simulation cycles based on the system clock for each clock domain; and
perform a stress test by randomly selecting a specific range above and below the default simulation cycle value for each clock domain.

2. The system of claim 1, wherein the random simulation environment is a single cycle simulation environment.

3. The system of claim 1, further comprising using a greatest common factor (GCF) mathematical formula to evaluate the common unit of time across the multiple clock domain values if decimal fraction domain frequency values are present, wherein a GCF is found among numerators of the decimal values and any non-decimal integer values and then divided by a common denominator of the decimal fractions to obtain a system clock cycle common unit of time.

4. The system of claim 3, further comprising representing the various domain clock frequency values as a number of simulation cycle values based on the system clock cycle.

5. The system of claim 4, further comprising automatically retrieving the simulation cycle values used by driver and monitor behaviorals.

6. The system of claim 1, wherein performing asynchronous interface stress test includes randomly selecting a simulation cycles percent variation for each domain clock frequency value.

7. The system of claim 6, wherein the randomization of the simulation cycles percent variation includes randomizing the range variation for each simulation run.

8. The system of claim 7, wherein the randomization is a minimum of one simulation cycle.

9. The system of claim 6, wherein the simulation cycle variation is selected at random on a per test case basis.

10. The system of claim 1, wherein the verification of various asynchronous frequency domains is part of the overall functional verification environment employing existing environment models and behaviorals.

11. The system of claim 6, wherein performing asynchronous interface stress testing includes dynamic control of the asynchronous interfaces using programmable independent oscillators.

12. The system of claim 1, further comprising using at least one of test cases, checkers, and monitors to verify and control the asynchronous random environment.

13. A method of verification of various asynchronous frequency domains in an electronic device in a random simulation environment, the method comprising:
inputting multiple domain clock frequency values;
determining whether any of the domain clock frequency values are decimal fractions; and
calculating a default domain simulation cycle by finding the greatest common factor (GCF) if there are no decimal fractions to represent each clock domain.

14. The method of claim 13, further comprising verifying functionality in a single cycle simulation environment using the calculated default domain simulation cycle.

15. The method of claim 13, further comprising using a greatest common factor (GCF) mathematical formula to evaluate a common unit of time across the multiple domain frequency values if decimal fraction domain frequency values are present, wherein a GCF is found among numerators of the decimal values and any non-decimal integer values and then divided by a common denominator of the decimal fractions to obtain a system clock cycle common unit of time.

16. The method of claim 15, further comprising representing the various domain clock frequency values as a number of simulation cycle values based on the system clock cycle.

17. The method of claim 16, further comprising automatically retrieving the simulation cycle values used by driver and monitor behaviorals.

18. The method of claim 15, further comprising performing asynchronous interface stress testing by randomly selecting a simulation cycles percent variation for each domain clock frequency value.

19. The method of claim 18, wherein the randomization of the simulation cycles percent variation includes randomizing the range variation for each simulation run.

20. The method of claim 19, wherein the randomization is a minimum of one simulation cycle.

21. The method of claim 18, wherein the simulation cycle variation is selected at random on a per test case basis.

22. The method of claim 13, wherein the verification of various asynchronous frequency domains is part of the overall functional verification environment employing existing environment models and behaviorals.

23. The method of claim 18, wherein performing asynchronous interface stress testing includes dynamic control of the asynchronous interfaces using programmable independent oscillators.

24. The method of claim 13, further comprising using at least one of test cases, checkers, and monitors to verify and control the asynchronous random environment.

25. A system for verification of various asynchronous frequency domains in an electronic device in a random simulation environment comprising:
a means for inputting multiple domain clock frequency values of the electronic device;
means for determining whether any of the domain clock frequency values are decimal fractions; and
means for calculating a default domain simulation cycle by finding the greatest common factor (GCF) if there are no decimal fractions to represent each clock domain.

26. The system of claim 25 further comprising a greatest common factor (GCF) mathematical formula to evaluate a common unit of time across the multiple domain frequency values if decimal fraction domain frequency values are present, wherein a GCF is found among numerators of the decimal values and any non-decimal integer values and then divided by a common denominator of the decimal fractions to obtain a system clock cycle common unit of time.

27. The system of claim 26 further comprising a means for performing asynchronous interface stress testing by randomization of the percent simulation cycles variation for each domain clock frequency value.

28. The system of claim 27, wherein the simulation cycle variation is selected at random on a per test case basis.

29. The system of claim 27, wherein the verification of various asynchronous frequency domains is part of the overall functional verification environment employing existing environment models and behaviorals.

30. A storage medium encoded with machine-readable computer code for verifying a hardware design of a system under evaluation via a test program executing on a computer, said storage medium including instructions for causing said computer to implement a method, comprising:
inputting multiple domain clock frequency values;
determining whether any of the domain clock frequency values are decimal fractions; and
calculating a default domain simulation cycle by finding the greatest common factor (GCF) if there are no decimal fractions to represent each clock domain.

31. The storage medium of claim 30, wherein the calculated default domain simulation cycle is used in a single cycle simulation environment to verify functionality of the hardware design.

32. The storage medium of claim 30, wherein the instructions further include using a greatest common factor (GCF) mathematical formula to evaluate a common unit of time across the multiple domain frequency values if decimal fraction domain frequency values are present, wherein a GCF is found among numerators of the decimal values and any non-decimal integer values and then divided by a common denominator of the decimal fractions to obtain a system clock cycle common unit of time.

33. The storage medium of claim 30, wherein the instructions further include performing asynchronous interface stress testing by randomly selecting a simulation cycles percent variation for each domain clock frequency value.
